(19) United States
(12) Patent Application Publication
(10) Pub. No.: US 2025/0323565 A1
(43) Pub. Date: Oct. 16, 2025

(54) HIGH EFFICIENCY REGULATED HYBRID CONVERTER WITH MULTIPLE CAPACITIVE CURRENT CARRYING BRANCHES

(71) Applicant: Renesas Design (UK) Limited, Bourne End (GB)

(72) Inventors: Nikhilesh KAMATH, Chandler, AZ (US); Sean Yitwei LAI, Chandler, AZ (US)

(73) Assignee: Renesas Design (UK) Limited, Bourne End (GB)

(21) Appl. No.: 18/631,741

(22) Filed: Apr. 10, 2024

(51) Int. Cl. H02M 1/00; H02M 3/07

(52) U.S. Cl. CPC H02M 1/0095; H02M 3/07

(57) ABSTRACT

A power converter configured to receive an input voltage via a voltage input port and output a predetermined output voltage via a voltage output port, comprising: two or more voltage rail provision cells connected between the voltage input port and ground; a switch network comprising a plurality of switches, configured to create a current path through the two or more voltage rail provision cells such that the two or more voltage rail provision cells provide two or more voltage rails each corresponding to a predetermined input to output voltage difference; at least one power storage cell connected between the two or more voltage rail provision cells and the voltage output port, wherein the at least one power storage cell is configured to output the predetermined output voltage to the voltage output port; a control circuit configured to control the switch network to select at least one voltage rail of the two or more voltage rails to set the predetermined output voltage.

The present disclosure relates to a power converter. In particular, the present disclosure relates to a power converter configured to receive an input voltage and output a predetermined output voltage via energy storage elements.

### BACKGROUND

In recent times, there has been increasing demand for extremely high efficiency power converter solutions. In some cases, it is required that output power capability be doubled while keeping overall thermal budget the same. In the consumer electronics space, every square millimetre of PCB area is accounted for and thus, minimal silicon die area and low external component count are critical when considering new solutions.

To increase power delivery capability while minimizing input current, one known solution is to raise the input voltage. However, this can increase losses of the power stage. Hence, this requires efficient power conversion with a higher step ratio (the ratio of input voltage to output voltage), with increased input voltage levels and low output voltage levels (for example, 20/24/28V input voltage levels to 1-4.8V output voltage range).

The present invention relates to power conversion topologies and control methodology, of which there are two common approaches: inductor-based converters (such as buck converters) and switched capacitor power converters (such as the Dickson converter).

Inductor-based switching power converters maintain a well-regulated output voltage over a wide input voltage range but are difficult to integrate and have a larger density/power because they require a power inductor.

Switched capacitor converters do not use a power inductor, have a smaller footprint, and better energy storage density, but they are limited to providing a fixed step-down ratio, wherein the output voltage tracks the input voltage, and do not provide a regulated output voltage.

FIG. 1 shows a circuit diagram of a switched capacitor power converter, specifically a 4:1 Dickson converter. The power converter is a single power stage which produces a fixed (unregulated) step down ratio.

Alternatively, a two-stage cascaded power conversion approach can be employed to take advantage of the positive qualities of both the switched capacitor power converter and the inductor-based power converter.

FIG. 2 shows a block diagram of a two-stage cascaded power converter in which a switched capacitor power converter circuit provides a first stage to lower an initial input voltage rail and where an intermediate voltage rail is input to an inductor-based power converter in a second stage, wherein the inductor-based power converter is used to provide a necessary regulated output voltage over the entire input voltage range.

However, although the two-stage cascaded solution goes some way to take advantage of the positive qualities of the switched capacitor power converter and the inductor-based power converter, it requires additional PCB area and has inherent power losses associated with each stage, reducing overall operational efficiency.

### SUMMARY

It is desirable to provide an improved power converter.

According to a first aspect of the disclosure, there is provided a power converter configured to receive an input voltage via a voltage input port and output a predetermined output voltage via a voltage output port, comprising:
two or more voltage rail provision cells connected between the voltage input port and ground;
a switch network comprising a plurality of switches, configured to create a current path through the two or more voltage rail provision cells such that the two or more voltage rail provision cells provide two or more voltage rails each corresponding to a predetermined input to output voltage difference;
at least one power storage cell connected between the two or more voltage rail provision cells and the voltage output port, wherein the at least one power storage cell is configured to output the predetermined output voltage to the voltage output port;
a control circuit configured to control the switch network to select at least one voltage rail of the two or more voltage rails to set the predetermined output voltage.

Optionally, the two or more voltage rail provision cells are two or more capacitor cells.

Optionally, the at least one power storage cell is at least one inductor cell.

Optionally, each of the two or more voltage rails is provided by two of the two or more capacitor cells.

Optionally, the power converter of claim 1, wherein the switch network creates the current path through the two or more voltage rail provision cells by switching each of the voltage rail provision cells to be connected to ground or the voltage output port;
each voltage rail provision cell is switchably connected to ground and the voltage output port.

Optionally, the selected at least one voltage rail is connected in series to provide the predetermined output voltage via the power storage cell.

Optionally, an additional voltage rail is added by connecting two additional voltage rail provision cells.

Optionally, each capacitor cell comprises:
a capacitor; and
at least one capacitor connecting switch of the switch network, wherein the at least one capacitor connecting switch connects the capacitor to one of the two or more voltage rails.

Optionally, each voltage rail providing cell comprises a first inductor.

Optionally, the switch network comprises:
three voltage input switches, wherein two of the voltage input switches connect an input voltage port to a capacitor of one of the two or more capacitor cells and a third voltage input switch connects the input voltage port to the inductor cell; and
a plurality of output voltage switches, wherein the output voltage switches connect the first set of capacitors and the second set of capacitors to the output voltage; and
a plurality of ground switches, wherein the ground switches connect the first set of capacitors and the second set of capacitors to ground.

Optionally, the control circuit controls the switch network to operate in a first mode in a first phase and a second mode in a second phase.

Optionally, the control circuit controls the switch network to alternate between the first mode and the second mode.

Optionally, a first set of capacitors of the two or more capacitor cells is charged in the first mode and discharged in the second mode; and
a second set of capacitors of the two or more capacitor cells is charged in the second mode and discharged in the first mode.

Optionally, the first set of capacitors are simultaneously charged in the first mode;
the second set of capacitors are simultaneously charged in the second mode; and
the first set of capacitors provide the two or more voltage rails in the first mode and the second set of capacitors provide the two or more voltage rails in the second mode.

Optionally, the first mode comprises:
charging the first set of capacitors; and
discharging the second set of capacitors to charge at least one capacitor of the first set of capacitors and/or magnetize a second inductor of the inductor cell; and
wherein the second mode comprises:
charging the second set of capacitors; and
discharging the first set of capacitors to charge at least one capacitor of the second set of capacitors and/or magnetize the second inductor of the inductor cell.

Optionally, the second inductor is connected between the voltage output port and one of the two or more voltage rails in the first mode such that the second inductor is magnetized according to a potential difference between the voltage rail and the voltage output port; and
the second inductor is connected between the voltage output port and another of the two or more voltage rails in the second mode such that the second inductor is magnetized according to a potential difference between the voltage rail and the voltage output port.

Optionally, the first mode and the second each comprise a second step; and
the second step of the first mode and the second mode comprises:
   demagnetizing the inductor of the inductor cell; and
   reducing a current applied across the inductor of the inductor cell.

Optionally, the charging and discharging of the first set of capacitors and the second set of capacitors is controlled by turning on and off the switches of the switch network.

Optionally, the charging of a first capacitor of the first set of capacitors is controlled by turning on one of the voltage input switches and connecting the first capacitor between the input voltage and the output voltage;
the charging the other capacitors of the first set of capacitors is controlled by turning on the at least one capacitor connecting switch and connecting the first set of capacitors to the second set of capacitors;
the charging of a second capacitor of the second set of capacitors is controlled by turning on one of the voltage input switches and connecting the second capacitor between the input voltage and the output voltage; and
the charging the other capacitors of the second set of capacitors is controlled by turning on the at least one capacitor connecting switch and connecting the second set of capacitors to the first set of capacitors.

Optionally, the two or more capacitor cells are connected to each other by a first plurality of switches of the switch network.

Optionally, the two or more capacitor cells are distributed on either side of the inductor cell such that a same number of capacitor cells are positioned on a left side and a right side of the inductor cell.

Optionally, the power converter comprises six capacitor cells and one inductor cell.

According to a second aspect of the disclosure, there is provided a method of setting an output voltage using a power converter configured to receive an input voltage via a voltage input port and output a predetermined output voltage via a voltage output port, the power converter comprising two or more voltage rails, the method comprising:
controlling, by a control circuit, a switch network comprising a plurality of switches to create a current path through two or more voltage rail provision cells such that the two or more voltage rail provision cells provide two or more voltage rails, wherein each voltage rail corresponds to a predetermined input to output voltage difference;
selecting, by the control circuit, at least one voltage input rail of the two or more voltage input rails to set a predetermined output voltage;
outputting, by a power storage cell connected between the two or more voltage rail provision cells and a voltage output port, the predetermined output voltage to the voltage output port.

### BRIEF DESCRIPTION OF THE DRAWINGS

The disclosure is described in further detail below by way of example and with reference to the accompanying drawings, in which:

FIG. 1 shows a switched capacitor power converter as is known in the prior art;

FIG. 2 shows a two-stage power converter as is known in the prior art;

FIG. 3 shows a block diagram representing a power converter;

FIG. 4 shows a block diagram representing a power converter;

FIG. 5 shows a circuit diagram representing a power converter;

FIGS. 6A and 6B show a circuit diagram representing a first switching sequence of a power converter; FIGS. 6C and 6D show a circuit diagram representing a second switching sequence of a power converter;

FIG. 7 shows a circuit diagram representing a power converter;

FIG. 8 shows a circuit diagram representing a power converter;

FIG. 9A shows a graph representing waveforms of a power converter; and FIG. 9B shows a graph representing waveforms of a power converter.

### DETAILED DESCRIPTION

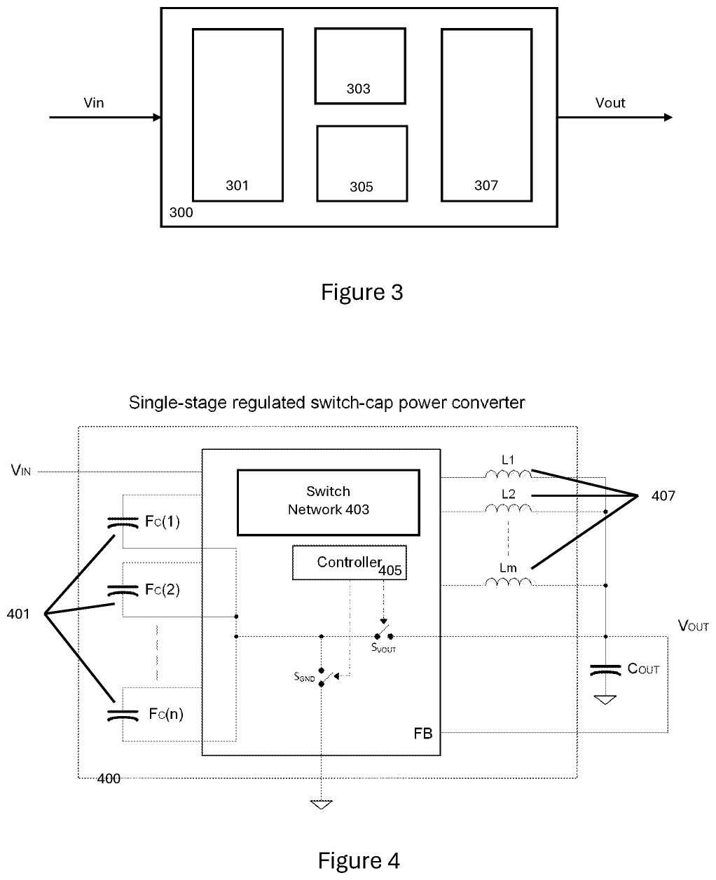

FIG. 3 shows a block diagram representing a power converter 300 according to a first embodiment. The power converter 300 is configured to receive an input voltage via a voltage input port and output a predetermined output voltage via a voltage output port. The power converter 300 comprises at least one voltage input port configured to receive an input voltage (for example, the input voltage may be a predetermined input voltage, or may be variable), at least one voltage output port configured to output an output voltage (for example, the output voltage may be a regulated output), two or more voltage rail provision cells (or modules or circuits) 301, a control circuit 303, a switch network 305 comprising a plurality of switches configured to create a current path through the two or more voltage rail provision cells 301 such that the two or more voltage rail provision cells provide two or more voltage rails each corresponding to a predetermined input to output voltage difference, and at least one power storage cell (or module or circuit) 307 connected between the two or more voltage rail provision cells and the voltage output port, wherein the control circuit 303 is configured to control the switch network to select at least one voltage rail of the two or more voltage rails to set a predetermined output voltage.

For example, the power converter 300 may be a hybrid power conversion circuit. The two or more voltage rail provision cells may be two or more flying capacitor voltage rail provision cells. The two or more voltage rail provision cells may be two or more capacitor cells. The at least one power storage cell may be at least one inductor cell.

The two or more voltage rails are provided by the two or more voltage rail provision cells. In more detail, each of the two or more voltage rails are provided by two of the two or more voltage rail provision cells. That is, the voltage rail provision cells are paired such that, for example, C1=C3=Vin−Vout; thus C1 and C3 provide a voltage rail with a potential difference of Vin−Vout.

The control circuit 303 is configured to select at least one voltage rail of the two or more voltage rails to set a predetermined (or desired or preset) output voltage. For example, each voltage rail may represent a specific potential difference provided by each voltage rail provision cell; as such, multiple voltage rails can be selected to set a specific output voltage. For example, the number of the individual voltage rails can be selected depending on the input voltage variance of the input voltage and the output voltage and a regulation tolerance. The selected at least one voltage rail is connected in series to provide the predetermined output voltage via the power storage cell. The control circuit 303 may be a driver circuit or the like.

The voltage input port may be shared by the two or more voltage rail provision cells 301 and at the least one power storage cell 307. The voltage output port may be shared by each of the two or more voltage rail provision cells 301 and the at least one power storage cell 307. For example, the bottom plate of each capacitor of the two or more voltage rail provision cells 301 may be switchably connected (that is, connected with a switch between) to the ground and, separately, the voltage output port.

The two or more voltage rails are provided by the two or more voltage rail provision cells 301 and the switch network 303, wherein the switch network 305 is configured to control the provision of current to each of the two or more voltage rail provision cells 301. Each voltage rail provision cell serves as a current path that acts as a voltage rail. The plurality of switches of switch network 305 can be opened or closed (turned ON or OFF) to control which voltage rail provision cells 301 are charged or discharged at different points in time. Thus, additional voltage rails can be added by connecting two additional voltage rail provision cells 301. The switch network 305 is controlled by the control circuit 303.

For example, the control circuit 303 may control the switch network 305 to operate (or implement) a switching sequence that causes a first set of capacitors (or other current storage device) of the two or more voltage rail provision cells 301 to charge while a second set of capacitors of the two or more voltage rail provision cells 301 discharges, or vice versa. The capacitors of the two or more voltage rail provision cells may be flying capacitors. The discharging of the second set of capacitors may charge some of the first set of capacitors, or vice versa. For example, a first capacitor may be charged at a first point in time and may discharge at a second point in time. At the first point in time the first capacitor may be charged either from Vin directly or may be charged by a second capacitor discharging (that is, the first capacitor is charged by current received from the discharging second capacitor); at the second point in time, the first capacitor may discharge to charge a third capacitor or may discharge to magnetize an inductor of the inductor cell 307. In some examples, the switches of the switch network 305 may be field effect transistors (FETs).

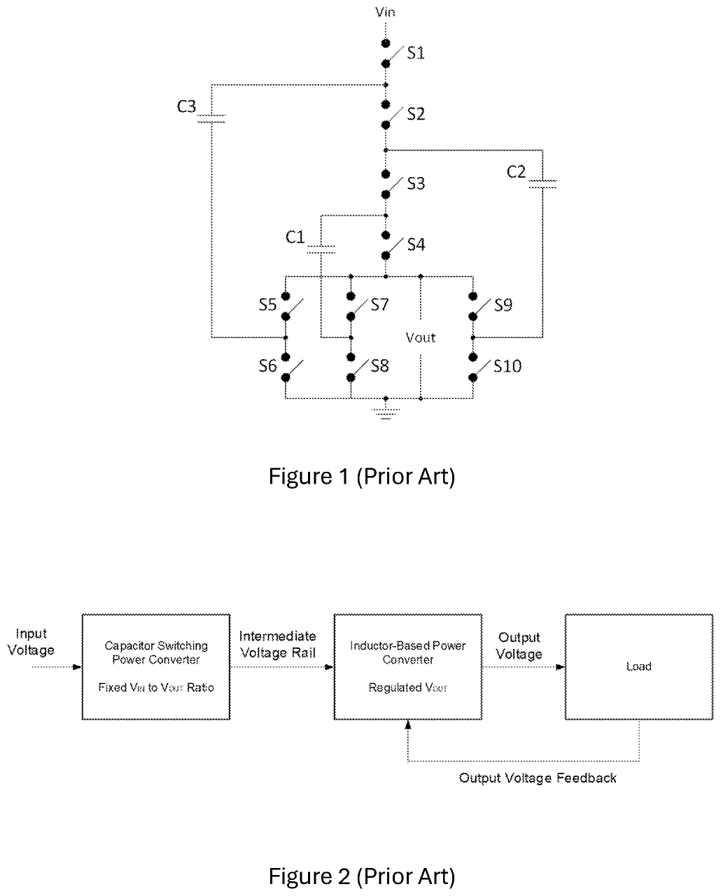

In some examples, the two or more voltage rail provision cells 301 may be switched capacitor circuits. For example, the two or more voltage rail provision cells may be switched capacitor circuits similar to the switched capacitor circuit shown in FIG. 1 (prior art).

In an example, each of the two or more voltage rails may be set to a different input to output voltage difference (the difference between the input voltage and the output voltage—for example, an intermediary input to output voltage difference) by virtue of being provided by the two or more voltage rail provision cells 301. Over the input voltage range, different combinations of the two or more voltage rails may be connected in series to provide a regulated voltage output. Thus, voltage output may be regulated over a wide input voltage range, by using combinations of the two or more voltage rails. For example, the two or more voltage rails may include four voltage rails wherein the four voltage rails have voltages corresponding to “Vin” (input voltage), “Vin−Vout” (where Vout is the output voltage), “Vin−2Vout” (where 2Vout is 2 times Vout), and “Vin−3Vout” (where 3Vout is 3 times Vout). In this example, six voltage rail provision cells may be provided, to provide the four voltage rails continuously.

In some examples, the power converter may be a circuit which is symmetrical such that an equal number of voltage rail provision cells are positioned on one side of the at least one power storage cell and another side of the power storage cell. That is, the two or more capacitor cells are distributed on either side of the at least one inductor cell such that a same number of capacitor cells are positioned on a left side and a right side of the inductor cell.

FIG. 4 shows a block diagram representing a power converter 400 according to the first embodiment. The power converter may be the same as the power converter 300 described by reference to FIG. 3.

The power converter comprises two or more voltage rails; a two or more capacitor cells (or circuits or modules) 401 (for instance, capacitor cells C1, C2, to capacitor cell Cn); a switching network 403; a control circuit (or controller) 405; at least one inductor cell 407 (for instance, inductor cells L1, L2 to inductor cell Lm); input voltage Vin; output voltage Vout; and switches S_{GND} and S_{VOUT}.

The power converter may be scalable. In more detail, the number of voltage rails may be increased by adding two additional capacitor cells 401 for each additional voltage rail. For example, to add an additional voltage rail, two additional capacitor cells may be connected. In another example, to add two additional voltage rails, four additional capacitor cells may be added. Additionally, additional inductor cells 407 may also be added.

In a preferred example, the power converter 400 may comprise four voltage rails provided by six capacitor cells, and one inductor cell. However, it should be understood that the number of capacitor cells and inductor cells can be changed based on desired input output voltage ratios. For example, eight capacitor cells may be used to provide five voltage rails (Vin, Vin−Vout, Vin−2Vout, Vin−3Vout, Vin−4Vout), or four capacitor cells may be used to provide three voltage rails (Vin, Vin−Vout, Vin−2Vout).

Each capacitor cell of the two or more capacitor cells 401 may comprise a capacitor and at least one capacitor connecting switch of the switch network 403, wherein the at least one capacitor connecting switch connects the capacitor to one of the two or more voltage rails (for example, by connecting to an adjacent capacitor cell of the two or more capacitor cells 401). The capacitor cells are connected to ground and the output voltage by switches S_{GND} and S_{VOUT}. For example, the bottom plate of each capacitor of each capacitor cell is switchably connected to both ground and the output voltage. For example, each capacitor may be switchably connected to ground and the output voltage by two switches per capacitor, or the two switches may be shared by a plurality (or group or set or number) of capacitors.

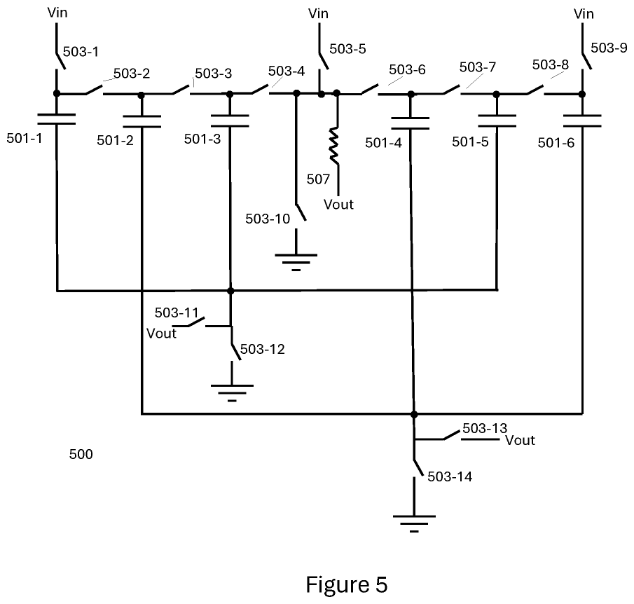

In a preferred example, each capacitor cell of the two or more capacitor cells 401 includes a capacitor, a switch connecting the capacitor to ground, a switch connecting the capacitor to Vout, and a switch connecting the capacitor to either another capacitor, belonging to another capacitor cell, or the at least one inductor cell 407. However, fewer switches may also be used, as described by reference to FIG. 5.

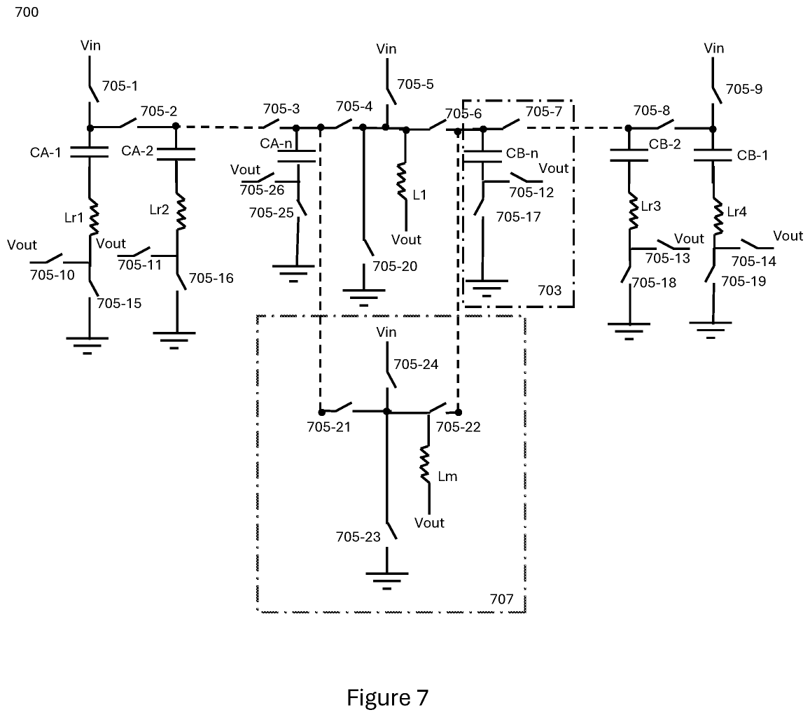

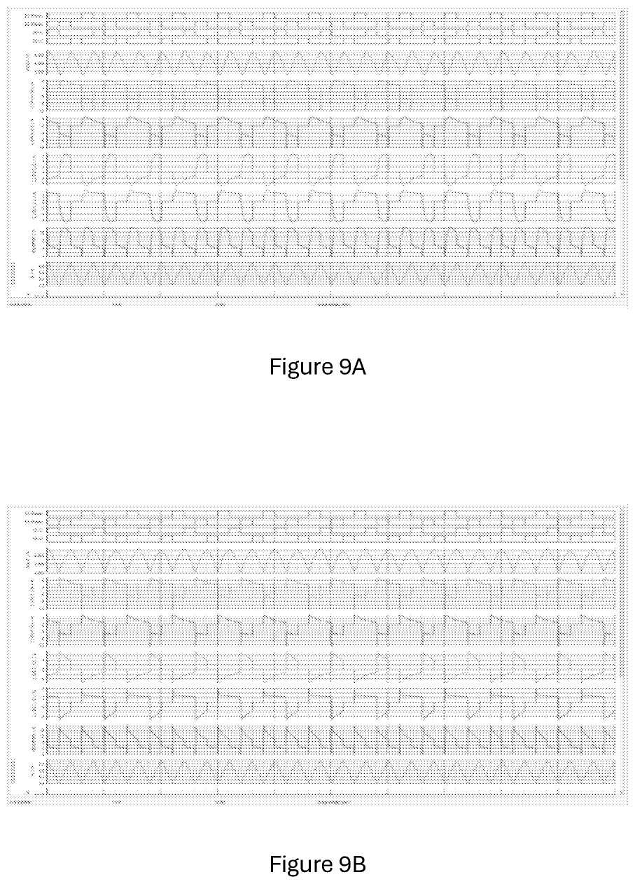

In alternative examples, each capacitor cell may also comprise an inductor (as shown in FIG. 7). These inductors facilitate soft charging of the capacitors, preventing re-distribution current spikes during the transfer of energy between capacitors. For example, the inductors may be parasitic inductances. This is further described by reference to FIGS. 9A and 9B.

FIG. 5 shows a power converter 500 according to a second embodiment. For example, the power converter may be a further example of the power converters 300, 400 described by reference to FIGS. 3 and 4.

In this embodiment, the power converter 500 includes six capacitor cells, wherein each capacitor cell includes a capacitor 501-1 to 501-6 and a switch, wherein the switches are part of a switch network (such as switch network 303 or 403). The capacitors are connected such that a first set of capacitors 501-1, 501-3, 501-5 are switchably connected to Vout and ground; and such that a second set of capacitors 501-2, 501-4, 501-6 are separately switchably connected to Vout and ground. That is, switch 503-11 is connected between the first set of capacitors 501-1, 501-3, 501-5 and Vout, and switch 503-13 is connected between the second set of capacitors 501-2, 501-4, 501-6 and Vout, allowing the switch network to form a current path through each capacitor to provide a voltage rail. Additionally, switch 503-12 is connected between the first set of capacitors 501-1, 501-3, 501-5 and the ground, and switch 503-14 is connected between the second set of capacitors 501-2, 501-4, 501-6 and the ground. This allows the control circuit to control the switch network to allow the first set of capacitors 501-1, 501-3, 501-5 and/or the second set of capacitors 501-2, 501-4, 501-6 to discharge to ground by controlling the switch network such that the first or second set of capacitors are connected to ground.

The switch network comprises switches 503-1 to 503-14. The switch network is controlled by a control circuit (not shown) such as the control circuits 305, 405 as described by reference to FIGS. 3 and 4.

That is, the switch network comprises three voltage input switches 503-1, 503-5, 503-9, wherein two of the three voltage input switches 503-1, 503-9 connect the input voltage to capacitor cells 501-1 and 501-6. Another voltage input switch 503-5 connects the input voltage to the inductor 507. The switch network also comprises at least two output voltage switches 503-11 and 503-13, wherein the at least two output voltage switches connect the first set of capacitors 501-1, 501-3, and 501-5 and the second set of capacitors 501-2, 501-4, and 501-6 to the output voltage, Vout; and at least three ground switches 503-10, 503-12, and 503-14, which connect the first set of capacitors, the second set of capacitors, and the inductor 507 to ground.

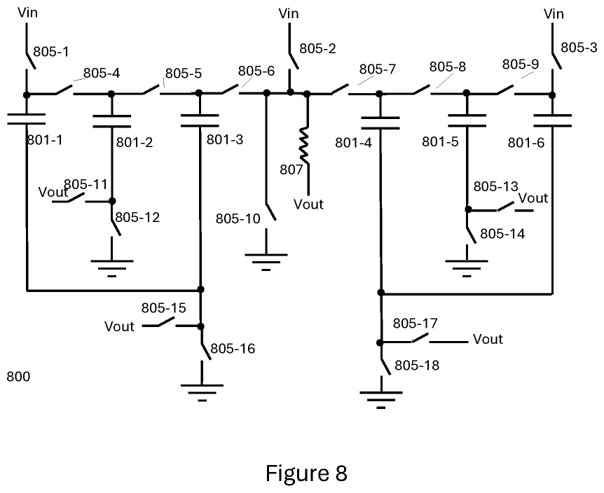

In alternative examples, the switch network may comprise a greater number of switches. For example, in a preferred example, each capacitor cell may include a switch to connect the capacitor to ground and a switch to connect the capacitor to Vout. In another alternative example, the power converter may be symmetrical and capacitors of each group on each side may share switches to connect the capacitors to ground and Vout (as will be described by reference to FIG. 8).

The control circuit may control the switch network to operate in a first mode in a first phase and a second mode in a second phase. In more detail, the switch network may be controlled by the control circuit such that in a first phase, a first plurality of switches of the switch network are closed (or ON), thereby allowing the first set of capacitors to charge and, in a second phase, a second plurality of switches of the switch network are closed (or ON), thereby allowing the second set of capacitors to charge. The first set of capacitors may discharge in the second phase and the discharged current may charge the second set of capacitors. The second set of capacitors may discharge in the first phase, and the discharged current may charge the first set of capacitors. The control circuit may control the switch network to alternate between the first mode and the second mode.

Thus, the switch network can be controlled (by the control circuit) to provide a set of voltage rails, which can be selected to provide a predetermined output voltage.

That is, each capacitor cell serves as a current path that acts as a voltage rail. As such, the capacitor cells can be replicated to provide additional voltage rails. Thus, the power converter 500 is scalable such that as many or as few voltage rails are required can be implemented to obtain a desired input: output ratios.

The power converter 500 further includes an inductor cell (for example, the inductor cell may be the same or similar to the inductor cells 307, 407 described by reference to FIGS. 3 and 4) that comprises an inductor 507, and switches 503-4, 503-5, 503-6, 503-10. Switch 503-5 connects the inductor 507 to voltage Vin, such that if the potential stored on the capacitor cell (for example, Vin−3Vout for capacitor 501-3) that is directly connected to the inductor cell falls below Vout, switch 503-5 allows the inductor 507 to access Vin as a pull-up voltage which can be used to magnetize the inductor. The inductor 507 of the inductor cell is magnetized by current discharged by capacitors 501-3 and/or 501-4 in order to output a desired output voltage.

FIG. 5 shows an example of a power converter with a minimal number of switches. It should be understood that other examples may include a greater number of switches (as described in FIGS. 7 and 8).

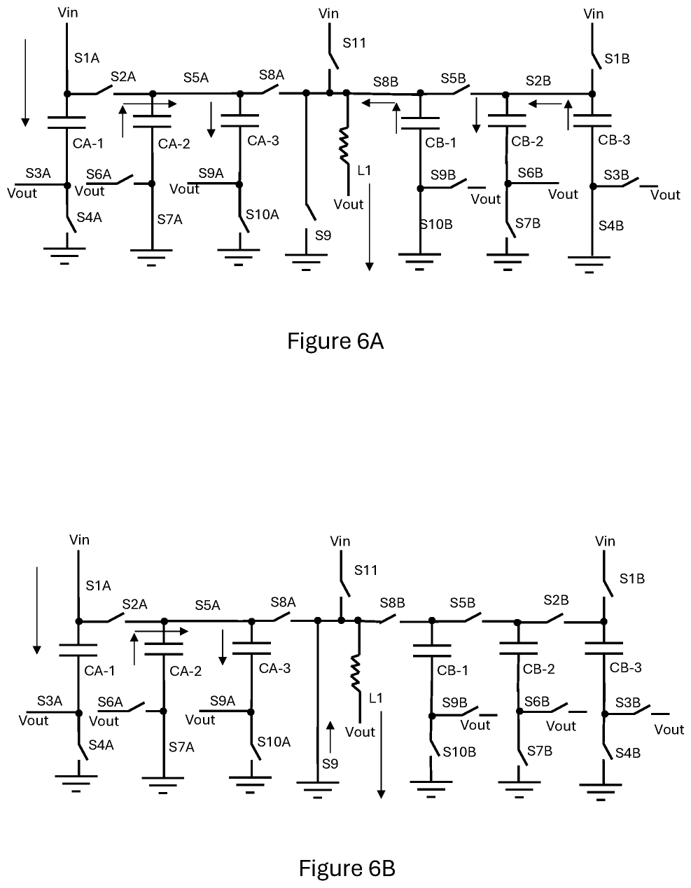

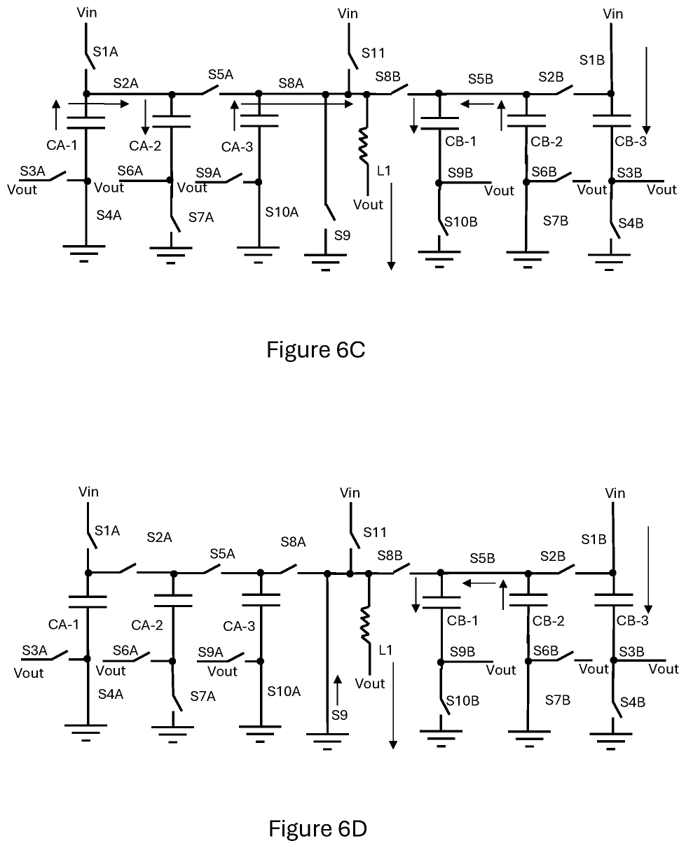

FIGS. 6A, 6B, 6C, and 6D show an example of a power converter, such as those described by reference to FIGS. 3, 4, and 5, operating in a first mode and a second mode, respectively. For example, the hybrid power converter circuit may operate in the first mode during a first phase and in the second mode in a second phase. The first mode and second mode may be alternated; for example, the hybrid power converter circuit may operate in the first mode, followed by the second mode, followed by the first mode and so on. The first mode and the second mode may both include a first step and a second step.

FIG. 6A shows the power converter operating in a first mode, wherein the power converter is performing a first step of the first mode. In the first step of the first mode switches S1A, S3A, S5A, S7A, and S9A (all odd-numbered switches on a left side of the inductor cell), and S2B, S4B, S6B, S8B, and S10B (all even-numbered switches on a right side of the inductor cell) are closed (or switched ON), allowing capacitors CA-1, CA-3, and CB-2 to charge simultaneously.

In more detail, on the left of the inductor cell, switches SIA and S3A are closed (ON), connecting capacitor CA-1 between Vin and Vout and charging the capacitor to Vin−Vout. Simultaneously, switches S7A, S5A, and S9A are closed (ON), connecting capacitors CA-2 and CA-3 and allowing transfer of charge from CA-2 to CA-3 (that is, capacitor CA-2 discharges, charging capacitor CA-3). In this example, capacitor CA-2 was previously charged to Vin−2Vout in a previous mode, thus causing capacitor CA-3, which is connected to Vout by switch S9A, to charge to a potential of Vin−3Vout.

On the right of the inductor cell, switches S2B, S4B, and S6B are closed (ON), connecting capacitors CB-3 and CB-2 and allowing transfer of charge from CB-3 to CB-2 (that is, capacitor CB-3 discharges, charging capacitor CB-2). Switches S10B and S8B are also closed (ON), allowing capacitor CB-1 to discharge and connecting a switch node connected to the inductor L1 between switches S8A and S8B to Vin−3Vout, resulting in inductor L1 being magnetized with a voltage (Vin−3Vout)−Vout. In more detail, when S8A and S10A are closed, one end of the inductor L1 is connected to a potential of Vin−3Vout, while another end of the inductor L1 is connected to Vout. As such, the voltage difference across the inductor L1 is (Vin−3Vout)−Vout, defining the magnetization voltage applied across the inductor L1.

Thus, the inductor L1 provides the voltage output port with a predetermined voltage of (Vin−3Vout)−Vout.

That is, the switch network creates a current path through the capacitor cells such that the capacitor cells provide the voltage rails. For example, when switches SIA and S3A are closed (ON), a current path is created through capacitor CA-1, thus providing a voltage rail with a potential difference of Vin−Vout. When switches S2B and S6B are closed (ON), a current path is created through capacitor CB-2, providing a voltage rail with a potential difference of Vin−2Vout. When switches S5A and S9A are closed (ON), a current path is created through capacitor CA-3, thus providing a voltage rail with a potential difference of Vin−3Vout. Thus, in the first mode, voltage rails Vin−Vout, Vin−2Vout, and Vin−3Vout are provided by creating current paths through capacitors CA-1, CB-2, and CA-3.

FIG. 6B shows a second step of the first mode, which happens once the peak inductor current is reached. On the right side of the inductor cell, switches S2B and S8B are turned OFF (opened), ending the magnetization step of the first mode. Switch S9 is turned ON (closed) and −Vout is applied to the inductor L1 to bring its current down. For example, the current may be brought down linearly.

FIG. 6C shows the power converter operating in a second mode, wherein the power converter is performing a first step of the second mode. In the first step of the second mode switches S1B, S3B, S5B, S7B, and S9B (all odd-numbered switches on the right side of the inductor cell), and S2A, S4A, S6A, S8A, and S10A (all even-numbered switches on the left side of the inductor cell) are closed (or switched ON), allowing capacitors CA-2, CB-3, and CB-1 to charge simultaneously.

In more detail, on the right of the inductor cell, switches S1B and S3B are closed (ON), connecting capacitor CB-3 between Vin and Vout and charging the capacitor to Vin−Vout. Simultaneously, switches S7B, S5B, and S9B are closed (ON), connecting capacitors CB-2 and CB-1 and allowing transfer of charge from CB-2 to CB-1 (that is, capacitor CB-2 discharges, charging capacitor CB-1). In this example, capacitor CB-2 was previously charged to Vin−2Vout in a previous mode, thus causing capacitor CB-1, which is connected to Vout by switch S10B, to charge to a potential of Vin−3Vout.

On the right of the inductor cell, switches S2A, S4A, and S6A are closed (ON), connecting capacitors CA-1 and CA-2 and allowing transfer of charge from CA-1 to CA-2 (that is, capacitor CA-1 discharges, charging capacitor CA-2). CA-2 charges to Vin−2Vout. Switches S10A and S8A are also closed (ON), allowing capacitor CB-1 to discharge and connecting a switch node connected to one end of the inductor L1 between switches S8A and S8B to Vin−3Vout, resulting in inductor L1 being magnetized with a voltage (Vin−3Vout)-Vout. Similar to as described above, when S8B and S10B are closed, one end of the inductor L1 is connected to a potential of Vin-3Vout, while another end of the inductor L1 is connected to Vout. As such, the voltage difference across the inductor L1 is (Vin−3Vout)-Vout, defining the magnetization voltage applied across the inductor L1.

Thus, again the inductor L1 provides the voltage output port with a predetermined voltage of (Vin−3Vout)−Vout in the second mode.

That is, the switch network creates a current path through the capacitor cells such that the capacitor cells provide the voltage rails. For example, when switches S1B and S3B are closed (ON), a current path is created through capacitor CB-3, thus providing a voltage rail with a potential difference of Vin−Vout. When switches S2A and S6A are closed (ON), a current path is created through capacitor CA-2, providing a voltage rail with a potential difference of Vin−2Vout. When switches S5B and S9B are closed (ON), a current path is created through capacitor CB-1, thus providing a voltage rail with a potential difference of Vin−3Vout. Thus, in the first mode, voltage rails Vin-Vout, Vin−2Vout, and Vin−3Vout are provided by creating current paths through capacitors CB-3, CA-2, and CB-1.

FIG. 6D shows a second step of the second mode, which happens once the peak inductor current is reached. On the left side of the inductor cell, switch S6A is turned OFF (opened), ending the magnetization step of the first mode. Switch S9 is turned ON (closed) and −Vout is applied to the inductor L1 to bring its current down. For example, the current may be brought down linearly.

Thus, it can be seen, in this example, that four voltage rails are provided: Vin, Vin−Vout, Vin−2Vout, and Vin−3Vout. The four voltage rails are provided by multiple capacitive current paths provided by a combination of the capacitor cells (or modules) and the switching network, and can be selected (by controlling the switching network) to provide a predetermined output voltage. The four voltage rails are provided continuously by implementing a symmetrical circuit structure and mirroring the function of left and right sides of the circuit across the two modes. That is, the left hand side of the circuit performs, in the first mode, the function of the right hand side of the circuit in the second mode, and vice versa. As such, the capacitors are continuously switching between charging and discharging.

FIG. 7 shows an example power converter which provides an example of how the capacitor cells and inductor cells may be replicated. An example capacitor cell is indicated by dot-dashed box 703 and an example inductor cell is indicated by dot-dashed box 707.

The example capacitor cell 703 comprises capacitor CB-n and switches 705-7, 705-12, 705-17. Switch 705-7 connects capacitor CB-n to another capacitor cell (such as the capacitor cell comprising capacitor CB-2). Switch 705-12 connects capacitor CB-n to Vout. Switch 705-17 connects capacitor CB-n to the ground. A current path can be created through capacitor CB-n, charging capacitor CB-n and providing a voltage rail with voltage Vin−nVout.

Thus, it can be seen that the power converter discussed herein can be scaled by adding additional capacitor cells to provide additional voltage rails.

The example inductor cell 707 comprises four switches 705-24, 705-21, 705-22, 705-23 and inductor Lm. Switch 705-24 connects inductor Lm to Vin, charging Lm to Vin−Vout if the voltage across the capacitors falls below Vout. Switches 705-21 and 705-22 connect inductor Lm to the capacitor cells to the left and right of the inductor cells, respectively. Switch 705-23 connects inductor Lm to the ground, allowing it to demagnetize after reaching peak current.

FIG. 7 also shows an example wherein each capacitor cell also includes an optional inductor Lr1 to Lr4. These inductors Lr1 to Lr4 facilitate soft charging of the capacitors, preventing re-distribution current spikes during the transfer of energy between capacitors. In other examples, there may be more or fewer inductors according to the number of capacitor cells; for example, if the power converter includes eight capacitor cells, six of the capacitor cells may include an inductor. The two capacitor cells connected to the at least one inductor cell do not require a parasitic inductor.

FIG. 8 shows a power converter 800 according to a third embodiment. The power converter 800 may work in substantially the same way as the power converters described by reference to FIGS. 3 to 7.

The power converter 800 is a symmetrical circuit comprising six capacitor cells distributed such that there are three capacitors on a right and three capacitors on a left side of the inductor cell. In more detail, capacitors 801-1, 801-2, and 801-3 are positioned on the left side of the inductor cell and capacitors 801-4, 801-5, and 801-6 are positioned on the right side of the inductor cell.

In this example, the capacitors which are odd-numbered (801-1, 801-3, 801-5) belong to a first set of capacitors and the capacitors which are even-numbered (801-2, 801-4, 801-6) belong to a second set of capacitors. For example, the first set of capacitors may be similar to the first set of capacitors described by reference to FIGS. 3 and 5.

The capacitors of the first set of capacitors that are positioned on the left side of the inductor cell (capacitors 801-1 and 801-3) are connected to switches 805-15 and 805-16. Switch 805-15 connects capacitors 801-1 and 801-3 to Vout. Switch 805-16 connects capacitors 801-1 and 801-3 to the ground.

The capacitors of the second set of capacitors that are positioned on the left side of the inductor cell (capacitor 801-2) are connected to switches 805-11 and 805-12. Switch 805-11 connects capacitor 801-2 to Vout. Switch 805-12 connects capacitor 801-2 to the ground.

Similarly, discussing now the right side of the inductor cell, capacitors of the first set of capacitors are connected to switches

It should be understood that in other examples, there may be additional capacitors on either side of the inductor cell; these capacitors would follow the same scheme of connection as is described for the specific circuit shown in FIG. 8.

Although the power converters described by reference to FIGS. 5 to 8 use a symmetrical (double-sided) array of capacitor cells or the like, it should be understood that it is not necessary that the circuits be symmetrical. In other examples, a single sided array of capacitor cells or the like may be used. For example, the capacitors can be grouped into a first group and a second group and connected such that even in a single sided array, the power converter is functionally the same.

FIGS. 9A and 9B show two sets of graphs representing steady state waveforms of a power converter such as the power converters described by reference to FIGS. 1 to 8.

FIG. 9A shows a set of graphs representing the steady state waveforms of a power converter wherein each capacitor cell (or voltage rail providing cell) comprises an inductor. In comparison, FIG. 9B shows a set of graphs representing the steady state waveforms of a power converter wherein each capacitor cell (or voltage rail providing cell) does not comprise an inductor.

It can be seen that the waveforms of FIG. 9A show smooth transitions throughout the switching sequence. Thus, it can be seen that the inclusion of inductors in the capacitor cells helps to prevent sharp changes in voltage across the capacitors. For example, referring to FIG. 6A, when switches S1A and S3A are closed (ON), connecting capacitor CA-1 between Vin and Vout, the inclusion of an inductor in the capacitor cell helps prevent large re-distribution current spikes that may occur when the capacitor voltage is far from the final target voltage of Vin−Vout.

Various improvements and modifications can be made to the above without departing from the scope of the disclosure.

1. A power converter configured to receive an input voltage via a voltage input port and output a predetermined output voltage via a voltage output port, comprising:
two or more voltage rail provision cells connected between the voltage input port and ground;
a switch network comprising a plurality of switches, configured to create a current path through the two or more voltage rail provision cells such that the two or more voltage rail provision cells provide two or more voltage rails each corresponding to a predetermined input to output voltage difference;
at least one power storage cell connected between the two or more voltage rail provision cells and the voltage output port, wherein the at least one power storage cell is configured to output the predetermined output voltage to the voltage output port;
a control circuit configured to control the switch network to select at least one voltage rail of the two or more voltage rails to set the predetermined output voltage.

2. The power converter of claim 1, wherein the two or more voltage rail provision cells are two or more capacitor cells.

3. The power converter of claim 2, wherein the at least one power storage cell is at least one inductor cell.

4. The power converter of claim 3, wherein each of the two or more voltage rails is provided by two of the two or more capacitor cells.

5. The power converter of claim 1, wherein the switch network creates the current path through the two or more voltage rail provision cells by switching each of the voltage rail provision cells to be connected to ground or the voltage output port;
wherein each voltage rail provision cell is switchably connected to ground and the voltage output port.

6. The power converter of claim 1, wherein the selected at least one voltage rail is connected in series to provide the predetermined output voltage via the power storage cell.

7. The power converter of claim 1, wherein an additional voltage rail is added by connecting two additional voltage rail provision cells.

8. The power converter of claim 3, wherein each capacitor cell comprises:
a capacitor; and
at least one capacitor connecting switch of the switch network, wherein the at least one capacitor connecting switch connects the capacitor to one of the two or more voltage rails.

9. The power converter of claim 1, wherein each voltage rail providing cell comprises a parasitic inductor.

10. The power converter of claim 3, wherein the switch network comprises:
three voltage input switches, wherein two of the voltage input switches connect an input voltage port to a capacitor of one of the two or more capacitor cells and a third voltage input switch connects the input voltage port to the inductor cell; and
a plurality of output voltage switches, wherein the output voltage switches connect the first set of capacitors and the second set of capacitors to the output voltage; and
a plurality of ground switches, wherein the ground switches connect the first set of capacitors and the second set of capacitors to ground.

11. The power converter of claim 2, wherein the control circuit controls the switch network to operate in a first mode in a first phase and a second mode in a second phase.

12. The power converter of claim 11, wherein the control circuit controls the switch network to alternate between the first mode and the second mode.

13. The power converter of claim 11,
wherein a first set of capacitors of the two or more capacitor cells is charged in the first mode and discharged in the second mode;
wherein a second set of capacitors of the two or more capacitor cells is charged in the second mode and discharged in the first mode.

14. The power converter of claim 13, wherein the first set of capacitors are simultaneously charged in a first step of the first mode;
wherein the second set of capacitors are simultaneously charged in a first step of the second mode; and
wherein the first set of capacitors provide the two or more voltage rails in the first mode and the second set of capacitors provide the two or more voltage rails in the second mode.

15. The power converter of claim 13, wherein the first step of the first mode comprises:
charging the first set of capacitors; and
discharging the second set of capacitors to charge at least one capacitor of the first set of capacitors and/or magnetize an inductor of the inductor cell; and
wherein the first step of the second mode comprises:
charging the second set of capacitors; and
discharging the first set of capacitors to charge at least one capacitor of the second set of capacitors and/or magnetize the inductor of the inductor cell.

16. The power converter of claim 15, wherein the inductor is connected between the voltage output port and one of the two or more voltage rails in the first mode such that the inductor is magnetized according to a potential difference between the voltage rail and the voltage output port; and
wherein the inductor is connected between the voltage output port and another of the two or more voltage rails in the second mode such that the inductor is magnetized according to a potential difference between the voltage rail and the voltage output port.

17. The power converter of claim 15, wherein the first mode and the second each comprise a second step;
wherein, in the second step of the first mode and the second mode, the inductor is connected between the voltage output port and ground such that the inductor is demagnetized according to a potential difference between the ground and the voltage output port to reduce a current applied across the inductor of the inductor cell.

18. The power converter of claim 16, wherein the charging and discharging of the first set of capacitors and the second set of capacitors is controlled by turning on and off the switches of the switch network.

19. The power converter of claim 18, wherein the charging of a first capacitor of the first set of capacitors is controlled by turning on one of the voltage input switches and connecting the first capacitor between the input voltage and the output voltage;
wherein the charging the other capacitors of the first set of capacitors is controlled by turning on the at least one capacitor connecting switch and connecting the first set of capacitors to the second set of capacitors;
wherein the charging of a first capacitor of the second set of capacitors is controlled by turning on one of the voltage input switches and connecting the second capacitor between the input voltage and the output voltage; and
wherein the charging the other capacitors of the second set of capacitors is controlled by turning on the at least one capacitor connecting switch and connecting the second set of capacitors to the first set of capacitors.

20. The power converter of claim 2, wherein the two or more capacitor cells are connected to each other by a first plurality of switches of the switch network.

21. The power converter of claim 3, wherein the two or more capacitor cells are distributed on either side of the inductor cell such that a same number of capacitor cells are positioned on a left side and a right side of the inductor cell.

22. The power converter of claim 3, wherein the power converter comprises six capacitor cells and one inductor cell.

23. A method of setting an output voltage using a power converter configured to receive an input voltage via a voltage input port and output a predetermined output voltage via a voltage output port, the power converter comprising two or more voltage rails, the method comprising:
controlling, by a control circuit, a switch network comprising a plurality of switches to create a current path through two or more voltage rail provision cells such that the two or more voltage rail provision cells provide two or more voltage rails, wherein each voltage rail corresponds to a predetermined input to output voltage difference, and wherein each voltage rail provision cell is connected between the voltage input port and ground;
selecting, by the control circuit, at least one voltage rail of the two or more voltage rails to set a predetermined output voltage;
outputting, by a power storage cell connected between the two or more voltage rail provision cells and a voltage output port, the predetermined output voltage to the voltage output port.
